(19) United States
(12) Patent Application Publication
(10) Pub. No.: US 2026/0367238 A1
(43) Pub. Date: Nov. 19, 2026

(54) ANGLE-RESOLVING RADAR SYSTEM

(71) Applicant: Robert Bosch GmbH, Stuttgart (DE)

(72) Inventors: Johannes Fink, Karlsruhe (DE); Werner Soergel, Pforzheim (DE)

(21) Appl. No.: 19/478,059

(22) PCT Filed: Jul. 12, 2024
(86) PCT No.: PCT/EP2024/069796

§ 371 Date: Oct. 23, 2025

(30) Foreign Application Priority Data
Sep. 18, 2023 (DE) 10 2023 209 014.7

(51) Int. Cl. G01S 13/46; G01S 13/00; G01S 13/931

(52) U.S. Cl. CPC G01S 13/46; G01S 13/003; G01S 13/931; G01S 2013/468

(57) ABSTRACT

An angle-resolving radar system. The system includes two radar sensors arranged at a given distance, the radar sensors being configured to transmit coherent radar signals and being oriented such that the signal transmitted by one of the radar sensors and reflected by an object can be received by the other sensor. The frequencies of the signals transmitted by the two radar sensors have a given frequency spacing. At least one of the radar sensors is configured to mix a signal transmitted by the other sensor and reflected by the object with the signal transmitted by the other sensor. An evaluation device is configured to compare the baseband signal generated by the mixing to a reference signal which is identical to the signal transmitted by the other sensor and to determine a location angle of the reflecting object based on the phase difference of these signals.

### FIELD

The present invention relates to an angle-resolving radar system comprising two radar sensors arranged at a given distance, the radar sensors being configured to transmit coherent radar signals and being oriented such that the signal transmitted by one of the radar sensors and reflected by an object can be received by the other sensor.

### BACKGROUND INFORMATION

Radar systems of the aforementioned type are referred to as cooperative radar systems and are increasingly being provided in motor vehicles for sensing the traffic environment.

Conventional angle-resolving radar systems are described e.g. in: Schoor, “Hochauflösende Winkelschätzung für automobile Radarsysteme”, Verlag Dr. Hut, 2010.

In angle-resolving SIMO radar systems, the size of the aperture is limited by the fact that only a limited number of receiving channels can be provided at reasonable expense. In MIMO (multiple-input, multiple-output) radar systems, an attempt is made to arrange the transmitting antennas and receiving antennas such that, with a given number of transmitting channels and receiving channels, a large virtual aperture and thus a high angular resolution are achieved and the side lobes that unavoidably arise in the case of a limited number of antennas due to antenna distances which, in some cases, are large are suppressed as much as possible. However, the goal of unambiguous and also high-resolution angle estimation is difficult to achieve with these approaches, for example in a compromise with reduced dynamic range.

### SUMMARY

An object of the present invention is to improve the angle estimation in a cooperative radar system.

This object may be achieved according to an example embodiment of the present invention in that the frequencies f1 and f2 of the signals transmitted by the two radar sensors have a given frequency spacing f2−f1, in that at least one of the radar sensors is configured to mix a signal transmitted by the other sensor and reflected by an object with the signal transmitted by the other sensor, and in that an evaluation device is configured to compare the baseband signal generated by the mixing to a reference signal which is identical to the signal transmitted by the other sensor and to determine a location angle of the reflecting object on the basis of the phase difference of these signals.

In cooperative radar systems, a very large aperture is achieved as a result of the large spatial distance between the two or more radar sensors. However, because these distances are significantly greater than the wavelength of the radar radiation, the Nyquist unambiguity criterion is massively violated. According to the present invention, the signals transmitted by the radar sensors are phase-locked to one another, but they have different frequencies. The frequency spacing between these signals makes it possible to generate a baseband signal having a substantially lower (beat) frequency f2−f1, said baseband signal corresponding to a fictitious radar wave having a correspondingly larger wavelength. The signal received from a radar target then has an angle-dependent phase difference relative to the reference signal, said phase difference making angle estimation possible. Because of the large wavelength of the simulated radar wave, the angle estimation is unambiguous at least in a wide angular range, and because of the large aperture, high resolution is nonetheless achieved.

The present invention is not limited to radar systems comprising exactly two radar sensors, but rather is analogously applicable also to cooperative systems comprising more than two radar sensors. In addition, the signal transmitted by each individual radar sensor can also be a superimposition of signals having multiple frequencies, provided that, for the two cooperating radar sensors, all frequency components have the same frequency spacing.

Advantageous embodiments and further developments of the present invention are disclosed herein.

The radar sensors involved in the cooperative system may themselves be angle-resolving in the sense that they also enable angle estimation solely on the basis of the signals transmitted and received by the same sensor. For example, one or more radar sensors of the system may be configured as MIMO radar sensors which have high angular resolution capability due to the short wavelength corresponding to the frequency f1 or f2 but have only a very limited unambiguous range because of the large aperture. For an object that can be located by both sensors, the unambiguous angle estimation on the basis of the baseband signal with the frequency f2−f1 can then be used to resolve the ambiguity of the high-resolution angle estimation.

When the detection range of a single radar sensor overlaps with the detection range of two adjacent sensors, that sensor can cooperate in each case with the neighbor that is also locating the object.

The radar signals transmitted by the various sensors may be derived, with phase locking, from a base frequency f0 of a synchronization signal, for example by multiplying f0 and modulating thereon a multi-tone baseband signal, in particular an OFDM (orthogonal frequency division multiplex) signal.

An embodiment example is explained in more detail in the following with reference to the figures.

### BRIEF DESCRIPTION OF THE DRAWINGS

FIG. 1 shows a block diagram of a radar system according to an example embodiment of the present invention.

FIG. 2 shows a diagram for illustrating the operation of an angle estimation method implemented in the radar system, according to an example embodiment of the present invention.

FIG. 3 shows a plan view of a motor vehicle having a radar system according to an example embodiment the present invention.

### DETAILED DESCRIPTION OF EXAMPLE EMBODIMENTS

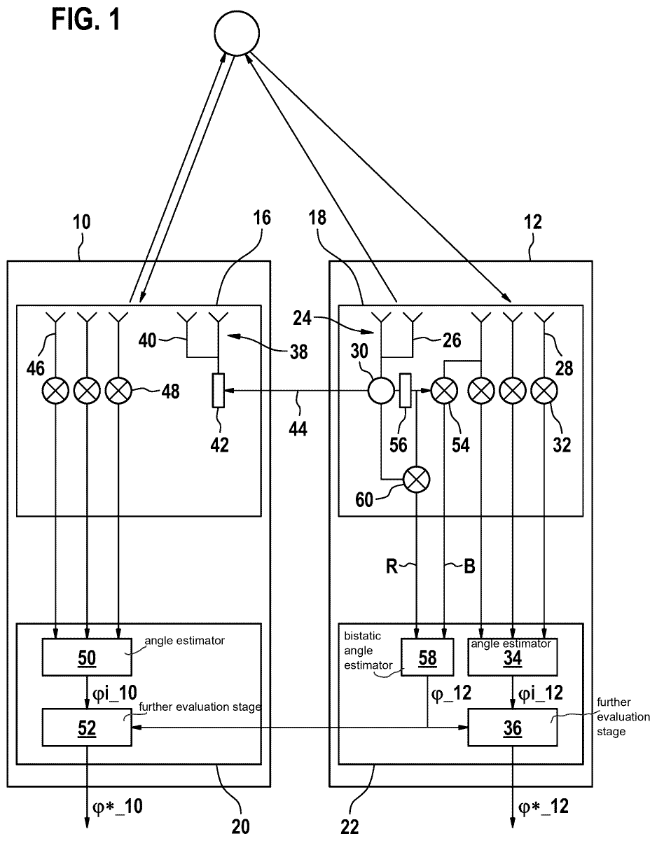

FIG. 1 shows, in the form of a block diagram, two cooperative radar sensors 10, 12 which, for example, are installed in a motor vehicle (not shown) such that their detection ranges overlap so that an object 14 present in the overlap region can be located by both sensors.

The two radar sensors 10, 12 are configured as MIMO radar sensors and each comprise a high-frequency part 16 and 18, respectively, and a digital evaluation device 20 and 22, respectively.

The high-frequency part 18 comprises a MIMO antenna array 24 having transmitting antennas 26 and receiving antennas 28. For purposes of clarity, only two transmitting antennas and three receiving antennas are shown here. The radar signal to be transmitted by the transmitting antennas 26 is generated by a local oscillator 30. Each of the receiving antennas 28 is assigned a mixer 32 which mixes the received signal with the signal generated by the local oscillator 30 (the corresponding signal lines are not shown here) so that an intermediate-frequency signal of low frequency is generated. The intermediate-frequency signals generated in the different receiving channels are digitized and are then further evaluated in the evaluation device 22. In a conventional way, an ambiguous set of estimated angle values φi_12 each indicating a candidate for the azimuth angle of the object 14 is generated in an angle estimator 34. The ambiguity is resolved in a further evaluation stage 36, as will be explained in further detail below.

The high-frequency part 16 of the sensor 10 comprises a MIMO antenna array 38, which may be structurally identical to the array 24 of the other sensor but is shown mirror-inverted here for clarity. The transmitting antennas 40 of the array 38 are fed by a modulator 42, which receives a synchronization signal 44 from the local oscillator 30 of the other sensor 12 and generates a transmission signal that is phase-locked to the transmission signal of the sensor 12. For example, the local oscillator 30 generates a signal having a frequency f1 of 76.5 GHZ, and the modulator 42 converts this signal, with phase locking, into a signal having a frequency f2 of 76.7 GHZ, with a fixed frequency spacing f2−f1=200 MHz.

Each receiving antenna 46 of the MIMO array 38 is assigned a mixer 48 which mixes the received signal with the signal generated by the modulator 42. The intermediate-frequency signals thus obtained in each receiving channel are digitized and are then further processed in the evaluation device 20. An angle estimator 50 generates an ambiguous set of estimated angle values φi_10, which are transmitted to a further evaluation stage 52.

Part of the signal transmitted by the transmitting antennas 46 of the sensor 10 may be reflected by the object 14 such that the reflected signal is received by the receiving antennas 28 of the sensor 12. At least one of these receiving antennas is capable of forwarding the received signal not only to the associated mixer 32 but also to a further mixer 54. Depending on the embodiment, the signal of this antenna may be split and fed to both mixers 32, 54, or there is alternating switching between the two mixers. The high-frequency part 18 of the sensor 12 includes a modulator 56 which has the same function as the modulator 42 in sensor 10 and thus generates a signal having the frequency f2. In the mixer 54, this signal is mixed with the signal received by the antenna. As a result, a baseband signal B is generated, the frequency of which approximately corresponds to the frequency spacing f2−f1 but depends on the time of flight of the signal from the transmitting antennas 46 via the object 14 to the receiving antennas 28 and thus on the location angle of the object.

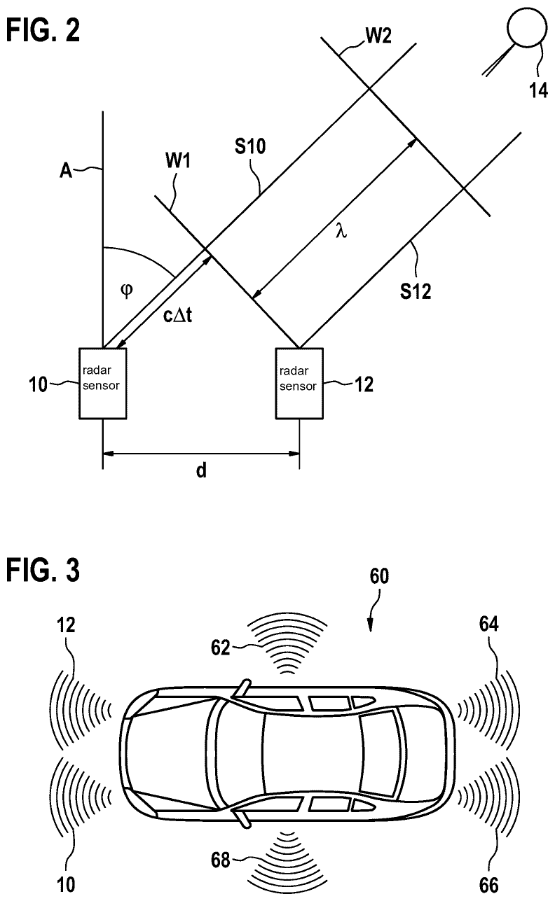

In the evaluation device 22, the baseband signal B is compared to a reference signal R in a bistatic angle estimator 58. This reference signal is generated by a mixer 60 which mixes the output signal of the local oscillator 30 with the output signal of the modulator 56. The reference signal R thus has exactly the frequency f2−f1. As will be explained in more detail below with reference to FIG. 2, an unambiguous value φ_12 for the azimuth angle of the object 14 can be determined from the phase difference between the baseband signal B and the reference signal R. This value is transferred to the evaluation stage 36 and makes it possible there to select, from among the high-resolution but ambiguous estimated values φi_12, the one that best matches φ_12 and thus indicates the true angle φ*_12 at which the object 14 is seen by the sensor 12.

Furthermore, the unambiguous value φ_12 is also transferred to the evaluation stage 52 in the sensor 10 and is used there to select, from among the high-resolution but ambiguous estimated values φi_10, the one that best matches φ_12 and indicates the true angle φ*_10 at which the object 14 is seen by the sensor 10.

The evaluation devices 20 and 22 contain further evaluation stages, which are not shown in FIG. 1 and which serve to determine the distance and the relative velocity of the object 14. For the angle estimation method proposed here, it is expedient if the signals transmitted by the transmitting antennas 26 and 40 have a fixed frequency or consist of a superposition of signals with fixed frequencies, as is the case with an OFDM radar, for example. In this type of radar, the transmitted signal is a superposition of orthogonal subcarrier frequencies that do not change over time. The waveforms of the transmitted signal are digitally modulated and form a sequence of code symbols which are digitally demodulated on the receiver side. Unlike in the case of, for example, an FMCW radar, here the distance information and angle information is thus obtained not by variation of the frequency over time, but by variation of the code symbols.

FIG. 2 schematically shows the two sensors 10, 12, which have a known distance d from one another of, for example, 75 cm. The distance to the object 14 is much greater than the distance d, and therefore the lines of sight S10 and S12 from the sensor 10 and the sensor 12, respectively, to the object 14 are nearly parallel. With the optical axis A of the sensor 10, the line of sight S10 forms the angle φ, which corresponds to the azimuth angle of the object 14. With the optical axis of the sensor 12 (not shown here), the line of sight S12 forms approximately the same angle.

FIG. 2 shows two wave fronts W1 and W2 of a fictitious wave which propagates at the speed of light c and has the frequency f2−f1 and thus the wavelength λ=c/(f2−f1). The wave front W1 has just reached the sensor 12 and will reach the sensor 10 with a time delay Δt, which is dependent on the location angle φ to the object 14 and is proportional to the path length difference c Δt=d sin(φ). The phase difference δ between the baseband signal B and the reference signal R is related to 2π as the path length difference c Δt is related to the wavelength λ. Thus, the location angle φ can be determined on the basis of the measured phase difference. The thus obtained estimated value for the location angle is unambiguous as long as the distance d=max{c Δt} is less than c/(2(f2−f1)).

FIG. 3 shows a plan view of a motor vehicle 60 equipped with a cooperative radar system. The radar system comprises a total of six radar sensors 10, 12 and 62 to 68, which are represented symbolically here in the form of stylized radar lobes. The radar sensors are, for example, OFDM radars which emit a sequence of code symbols with fixed subcarrier frequencies within each measurement cycle. The sequences of transmitted signals are interrupted by transmission breaks in which the received radar echoes are electronically evaluated. The measurement cycles of all six radar sensors are synchronized with one another. The radar sensors of each pair of adjacent sensors may cooperate with one another. For example, the sensor 12 may cooperate with the sensor 10, or with the sensor 62. Whenever two sensors locate the same object, they may cooperate with one another and perform an accurate angle estimation in the manner described above. If a single object is in the detection range in front of three or more radar sensors, the angle estimation method can be further refined by evaluating the phase differences and distances of these multiple sensors.

1-6. (canceled)

7. An angle-resolving radar system, comprising:
two radar sensors arranged at a given distance from one another, the radar sensors being configured to transmit coherent radar signals and being oriented such that the signal transmitted by one of the radar sensors and reflected by an object can be received by the other of the radar sensors, wherein frequencies of the radar signals transmitted by the two radar sensors have a given frequency spacing, at least one of the radar sensors is configured to mix a signal transmitted by the other of the sensors and reflected by the object with a signal transmitted by the other sensor; and
an evaluation device configured to compare a baseband signal generated by the mixing to a reference signal which is identical to the signal transmitted by the other sensor and to determine a location angle of the reflecting object based on a phase difference of the baseband signal and the reference signal.

8. The radar system according to claim 7, wherein the system comprises at least three radar sensors which cooperate with one another when locating the same object.

9. The radar system according to claim 7, wherein at least one of the radar sensors is angle-resolving on its own.

10. The radar system according to claim 9, wherein the at least one angle-resolving radar sensor is a multiple-input, multiple-output (MIMO) radar.

11. The radar system according to claim 9, wherein the at least one angle-resolving radar sensor is configured for high-resolution but ambiguous angle estimation and the location angle obtained by cooperation of the radar sensors is used to resolve the ambiguity.

12. The radar system according to claim 7, wherein at least one of the radar sensors is an orthogonal frequency division multiplex (OFDM) radar.
